(19) United States
(12) Patent Application Publication
(10) Pub. No.: US 2014/0122053 A1
(43) Pub. Date: May 1, 2014

(54) SYSTEM AND METHOD FOR PROVIDING WORLDWIDE REAL-TIME PERSONAL MEDICAL INFORMATION

(71) Applicants: MIREL LOTAN, RISHON LE ZION (IL); YAEL ANAT GIL, RISHON LE ZION (IL); SHAI COHEN, RISHON LE ZION (IL)

(72) Inventors: MIREL LOTAN, RISHON LE ZION (IL); YAEL ANAT GIL, RISHON LE ZION (IL); SHAI COHEN, RISHON LE ZION (IL)

(21) Appl. No.: 13/659,990

(22) Filed: Oct. 25, 2012

(51) Int. Cl. G10L 21/00; G06F 17/28

(52) U.S. Cl. CPC G10L 21/00; G06F 17/28
USPC 704/2; 704/270.1

(57) ABSTRACT

The present invention relates to preparing for all kinds of emergency by storing personal medical information and providing on site, real-time medical information during an emergency event or visit to a medical practitioner. An internet-connected device is used to contact the system's server via the Internet, for subscribing and entering personal medical information, preferably with biometric data, into the system's database. In case of emergency, any phone can be used to contact an Interactive Voice Response (IVR) system, which prompts the caller for identification pre-stored in the system's database to identify the subscriber. Upon positive identification, the IVR automatically translates the IVR menu language into the local language, contacts the system's server to access the system's database and provides the personal medical information in the chosen manner. Each call generates, in real time, a new event in an Event Log, which can be used to manage rescue activity from announcement to activity closure.

### FIELD OF THE INVENTION

The present invention relates to preparing for all kinds of emergencies by means of storing and providing personal medical information, in general, and, in particular to worldwide providing on the spot medical real-time information during an emergency event.

### BACKGROUND OF THE INVENTION

A personal incident or a mass disaster that leads to an emergency situation can happen without warning to anyone and those who have health constraints are more susceptible to emergencies. Mitigation of the consequences of an emergency is one of the most important and complex fields, in order to reduce risk and save lives. Preparing in advance for an emergency can reduce anxiety and risks to life.

In addition, the number of people suffering from medical conditions, such as high blood pressure, diabetes, heart conditions, diverse allergies, celiac disease, asthma, ulcers, HIV and more, is continually increasing. Many of these conditions limit the types of medical treatment which the person can receive without endangering his health or causing deterioration. The best medical treatment is the one that individually fits the person according to his or her personal health constraints. The individual's personal medical information is private but in case emergency medical assistance is required, it is crucial that the medical practitioner on the field will have immediate access to this personal information. In emergency situations, time is one of the most critical parameters for saving lives.

During an emergency event, the medical practitioners, such as doctors, Emergency Medical Technicians (EMTs), or other first responders, are never in possession of sufficient medical background information about the injured patient, so their ability to provide the proper personal medical treatment is significantly hindered. In fact, the high availability of relevant personal medical information during an emergency can significantly improve the patient's chances for survival. Otherwise, due to lack of information, the administered medical treatment, itself, could be life-threatening. Therefore, when an emergency event occurs, the injured person needs to have immediate access to his or her own medical information. From the medical practitioner's point of view, the ideal situation involves patients for whom he can access recorded medical health background.

Another major problem that medical practitioners often face is the identification of an unconscious or seriously injured patient. In an emergency situation, it can be extremely difficult to identify an unconscious patient or a patient who cannot communicate or provide information about him or herself, in order to gain access to their personal medical background and other medical information and/or to inform friends and family of his condition for alert purposes.

Sometimes, due to isolated locations, such as deserts, natural preserves, mountains, jungles, etc., first responders are unaware of the location of injured or trapped patients. In case of mass destruction events, such as earthquakes; it might be difficult for the patients to contact and alert the local authorities, due to the large number of people trying to contact the authorities at the same time. This burden is made worse by uninjured parties who try to contact the authorities to provide information about their loved ones or to enquire about the situation. Manned information centers are likely to collapse under this burden, or at least there can be extremely long wait times for people attempting to contact the authorities. In both cases, these information centers will mostly become irrelevant for emergency response. Even if contact is made, it is often difficult for the authorities to manage the rescue efforts when large masses of injured people are involved. Therefore, there is a long felt need for an easy, handy and convenient way to access personal medical emergency information when and where it is needed. Over the decades, tourism has experienced continued growth to become one of the fastest growing economic sectors in the world. Therefore, it would be desirable that this integrated method of accessing medical emergency information also be available worldwide across geographic borders. It also can help the local authorities to better manage and follow rescue efforts in case of national emergencies. Supporting easy global access to the medical information requires automatic worldwide geographical localization of the call, preferably based on the local phone company supplier, and translation of the system's language accordingly.

### SUMMARY OF THE INVENTION

According to the present invention, there is provided an integrated global system and method for providing personal medical information. The system handles the entire process, from the moment the medical team is deployed to the event location, including identification of the injured person, translation to local language, access to personal medical information, medical assessment according to health constraints, triage, handover to an emergency room and reporting in an event log. All the activity is performed wherever necessary, near the injured person. The system includes a database for entering and retrieving personal medical information associated with personal identification data, a server coupled to the database for storing and managing the personal medical information in the database and retrieving at least some of the personal medical information from the database, immediately when needed. Preferably, a DNA identification system is also provided, making it possible to identify unconscious injured subscribers. In order to service and efficiently respond to high emergency call volumes, an Interactive Voice Response (IVR) system is introduced into the system which includes an automatic language translation unit to interact with patients, regardless of their location on the planet. The IVR system is coupled to a geographic location identification unit, which automatically determines the local language and translates the IVR's menu accordingly. Via one simple local or international call, followed by identification, the system is capable of accessing the server via the IVR system and retrieving at least some of the personal medical information from the database in a language selected by the subscriber or automatically selected according to the geographic identification of the location of the device. The system requires no Internet connection. All types of telephone lines are suitable to activate the system.

There is also provided a method for retrieving personal medical information of a subscriber. The method includes accessing an Interactive Voice Response (IVR) unit connected to a database storing personal medical information associated with personal identification data, selecting a language for communicating with the IVR system, identifying a subscriber using a subscriber's access code, and automatically retrieving at least some of the personal medical information for the identified subscriber from the database. Alternatively, in case the patient is unconscious, the database can be accessed directly by medical personnel, after the patient has been identified using the personal identification data, for retrieval of personal medical information. In this case, as well, the call from the medical personnel will be geographically located by the geographical location unit and the IVR's menu will be automatically translated according to the local language. In addition or instead, the medical information can be retrieved in its original language or in the local language of the location of the calling device during retrieval.

Preferably, the method includes receiving an incoming call from a calling device in the IVR system, identifying a geographic location of the calling device, and selecting a language in which to communicate with the IVR during the call. The method further includes receiving personal identification data by the IVR system from the calling device to permit identification of the subscriber, who has personal medical information and personal identification data stored in a memory device coupled to the IVR system. The system then automatically retrieves at least some of the personal medical information of the identified subscriber from the memory device.

According to some scenarios, the method further includes entering personal medical information into the database and storing the personal medical information associated with personal identification data and, possibly, with translations of the medical data into at least one other language.

According to other applications of the invention, the method also includes sending at least one, and possibly several simultaneous voice or written messages using the IVR system over a communication system.

Because of the unforeseen nature of emergencies, the database is available at all times. Therefore, the entire database is fully and constantly backed up and recoverable as necessary.

### BRIEF DESCRIPTION OF THE DRAWINGS

The present invention will be further understood and appreciated from the following detailed description taken in conjunction with the drawings in which:

FIG. 1 is a schematic illustration of an integrated system for storing and retrieving personal medical information, constructed and operative in accordance with one embodiment of the present invention;

FIGS. 2a and 2b are examples of screen shots of one embodiment of a website used with the system of FIG. 1;

FIG. 3 is an exemplary illustration of a QR code suitable for use with the system of FIG. 1;

FIG. 4 is a block diagram illustrating a method of retrieving personal medical information and sending messages using an IVR system, according to one embodiment of the present invention;

FIG. 5 is a flow chart of an exemplary registration process; and

FIG. 6 is a flow chart of an exemplary method of using the system during an emergency.

### DETAILED DESCRIPTION

The present invention relates to preparing for all kinds of emergencies by storing in advance and providing, in real time and at the event's location, personal medical information. The basic assumption is that most people have some kind of medical constraints which differ from one another. This information is crucial at the time of an emergency or during medical treatment by a new doctor. This medical background allows a practitioner to adopt the most suitable medical treatment for the individual subscriber. The personal medical information is recorded into the system by the subscriber and updated when and if needed. In case an emergency incident occurs or up to date information regarding the subscriber's medical information is required, the subscriber calls an Interactive Voice Recognition (IVR) system connected to a server, from anywhere on earth and identifies himself by his personal code. The system automatically verifies the patient's identity, determines the location of the caller by country and provides the pre-stored medical information via any one of several potential communication channels. The personal medical information includes at least one personal medical detail, such as the blood type, a pre-existing medical condition, allergies or medicinal regimen, that can be critical to providing suitable emergency medical care to the patient (hereafter: a subscriber) during an emergency and potentially prevent an error due to medical mistreatment. This information can be provided to a medical care giver in the subscriber's native language, in the language of the geographic location of the subscriber's phone device, or another language selected by the medical care giver. The system can also be used in an emergency event to send mail or voice messages to the local authorities, or to friends and family, for notification, alert and/or tracking purposes via an appropriate communication system.

There is provided according to the present invention a system for storing and retrieving personal medical information including a memory device storing a database of personal medical information associated with personal identification data and a server including a controller coupled to the memory device for managing the personal medical information in the database and retrieving at least some of the personal medical information from the database. An Interactive Voice Response (IVR) system is coupled to the server and is accessible by a calling device over any telephone line. The system further includes a subscriber identification unit, for identifying a subscriber according to at least some of the personal identification data stored in the database and personal identification data received by the IVR system, as well as an automatic language translation unit coupled to the IVR system. The automatic language translation unit is configured to selectively translate the IVR system's menu to a language understood by a caller to the IVR system. A geographic location identification unit is coupled to the IVR system and is configured to determine a geographic location of the calling device and send a signal corresponding to the determined geographic location to the translation unit.

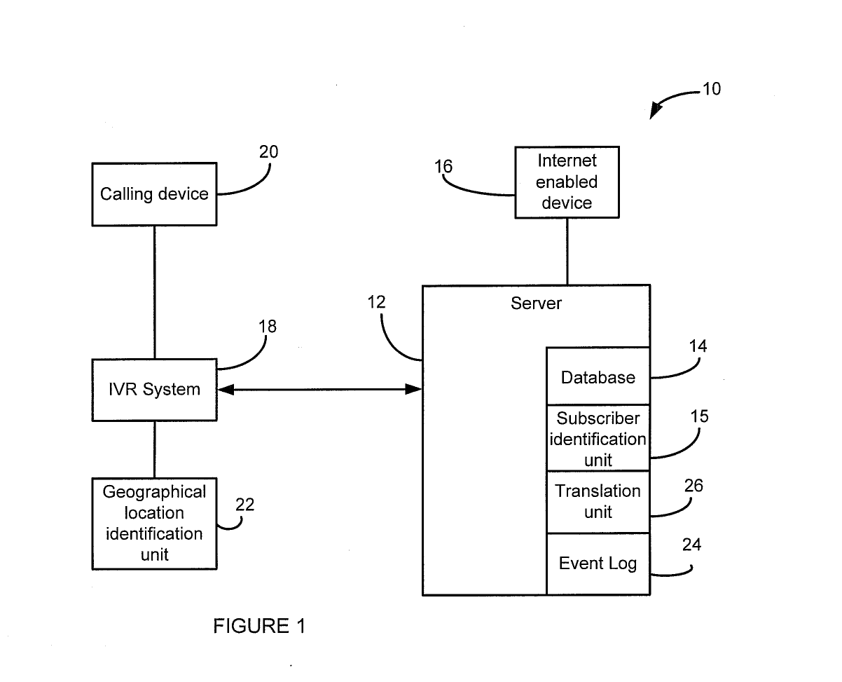

Referring to FIG. 1, there is shown a block diagram of a system 10 for storing and providing personal medical information, constructed and operative in accordance with one embodiment of the present invention. The system 10 includes a server 12 including a database 14 for storing the personal medical information of numerous subscribers. Subscriber identification data are also stored in the database 14, associated with the personal medical information of the particular subscriber. This subscriber identification data can be, for example, the subscriber's retrieval password, his or her QR code or other graphic code, if available, biometric data, such as a voice sample, a fingerprint scanned by a mobile device or application on a smart-phone, a picture of the face for facial recognition, a picture of the teeth, for dental recognition, DNA profile, a retinal scan for retinal identification, or any other suitable data.

The biometric database preferably is stored on the system server, rather than on the portable scanner device or cellular phone which might be used only to scan the fingerprint, for example. This enables use of a much larger amount of memory and also increases the level of security of the medical information database. Usually fingerprint portable scanners include databases on the mobile device, which can be unreliable in case of a lost device, because the medical database might fall into the wrong hands. However, alternatively, the biometric data can be stored on the portable device.

Server 12 also includes an Identification Verification (ID) unit 15. ID unit 15 is configured to use the subscriber's personal identification data to identify the subscriber in an emergency, and to permit viewing of the identified subscriber's personal medical information stored in the database 14. The biometric data that is stored may be used to identify a subscriber even if he or she is unconscious or otherwise unable to identify himself, as described below. Identification of unconscious injured subscribers and permitting automatic retrieval of the subscriber's personal medical information allows proper and reliable medical treatment to be performed, prevents deterioration of the subscriber's health condition, and allows the subscriber's family to be notified. This personal medical information and personal identification data may be entered into the database or memory 14 using any Internet enabled device 16, whether computer, smart phone, tablet or any other device, that can access the website of the server 12. Each subscriber has an editing password to enable signing-in and editing his or her personal information stored in the database 14, preferably after biometric identification, and an additional retrieval password to enable signing in and retrieval of his or her personal information from the memory in the server. This retrieval can be used for mere display, or for downloading and transfer to another location or device, etc. The retrieval password can be oral or written, permitting access either via an IVR system as described below, via voice control or through the server. Alternatively or in addition to an oral or written retrieval password, the subscriber's biometric data can be used as a retrieval password.

The database 14 can be accessed through the server 12 via an IVR (Interactive Voice Response) unit 18, or VRU (Voice Response Unit). The IVR system can be a conventional automated telephone information system that speaks to the caller with a combination of fixed voice menus and data extracted from databases in real time. The caller responds by pressing digits on the telephone or speaking words or short phrases. The IVR system may reside in a personal computer or server equipped with specialized PCI cards that connect to the telephone system to switch the calls. Alternatively or in addition, the system can be networked on a Local Area Network. The IVR system 18 can be contacted by a calling device 20 over a phone line (land, cellular, satellite, etc.), and used to help identify an injured person, if he or she is a subscriber, by using the subscriber's subscriber identification data. Calling device 20 can be any device capable of two-way communication with the IVR system 18, which typically will be a cellular phone.

According to some preferred embodiments, a geographic location unit 22 is coupled to the IVR system 18 or incorporated into server 12. Geographic location unit 22 is configured to determine the geographic location of the subscriber's calling device 20 and output a signal corresponding to said determined geographic location, which is particularly useful in cases where the subscriber is lost or unconscious. In such cases, the fact that the IVR system 18 is multilingual is very useful. The geographical location unit 22 can be any suitable unit for determining geographical location of the device, using, for example, GPS tracking, cellular roaming, simple detection by the phone company supplier, or using any other means.

An automatic language translation unit 26 is coupled to the IVR system 18 and to the geographic location unit 22 and configured to selectively translate the IVR system's menu to a language understood by a caller to the IVR system. This can be accomplished by configuring the menu language of the IVR system 18 to change automatically in accordance with the country from which the call originates (for example, English, Spanish, French, German, Chinese, Russian, Hebrew, etc), in response to the output signal from the geographic location unit 22. Alternatively, the default menu when the IVR system 18 answers the call can be the user selection of a requested language, for example, if the subscriber himself is calling and/or the caller does not speak the local language.

The personal medical information stored in the system's database 14 can be stored in English in order that the medical terminology can be understood by medical practitioners around the world. Alternatively, the database 14 can store translations of the medical data in various languages and permit retrieval of the medical information in the selected language. According to another embodiment, the automatic translation unit 26 can be configured to translate the data at the time of downloading to the local language or another selected language.

Since an important use of the present system is as an emergency information system, each call is referred as an emergency event and entered into an Event Log. The system preferably includes a computerized event log 24 that is preferably stored in the database 14. It will be appreciated that the IVR system preferably includes a recording device for recording digital data of each call (e.g., time, calling device identification, the message received in the IVR system) for storage in the event log 24. As a result of a caller contacting the IVR 18, a new log entry will be automatically added into the event log 24 as a new emergency event which should be handled until closure. Each log entry is identified by a specific number and may include any messages that were sent by the caller during the call. In case of an emergency, the user can choose where he wishes the emergency message, which was registered in the event log 24, to be sent. The message/voicemail will be sent via a suitable communication system to every mail address that the subscriber chose in advance when inputting his preferences, and also to the e-mail address of the security or local rescue forces, which may be stored in the server and selected as a default as a result of the geographical location. Instead of this default e-mail, the user can choose the rescue forces to whom he wishes the emergency message registered in the event log 24 to be sent.

Preferably, the event log 24 is immediately updated by the server 12 in real time after a caller (who may or may not be the subscriber) contacts the system 10. Each time a call is made to the IVR system 18, details of the subscriber and of the call (i.e., geographic location, downloaded information) are recorded in the event log 24. The event log 24 provides the emergency forces the actual location of the trapped people. Therefore, it can be used by the authorities in a national emergency mass destruction event to coordinate rescue efforts and save lives as quickly as possible. In some embodiments, a caller or care taker can add or record a note in the event entered into the event log 24, for example, of the on-site treatment that was administered on the subscriber.

Alternatively, or in addition, statistical tools may be provided to permit web administrators, emergency forces managers, medical providers, or other appropriate personnel to access and utilize the data in the event log, such as statistical data regarding messages, calls for aid, type of treatment, etc., preferably permitting searches according to key words. Preferably, the system 10 can also connect to and communicate with other external databases, such as those belonging to police, hospitals, insurance companies, etc. Preferably, access to the Event Log 24 will be allowed only to trained users as administrators. The user could input a time frame for which he is interested in seeing recorded events (e.g., from a certain date until a certain date).

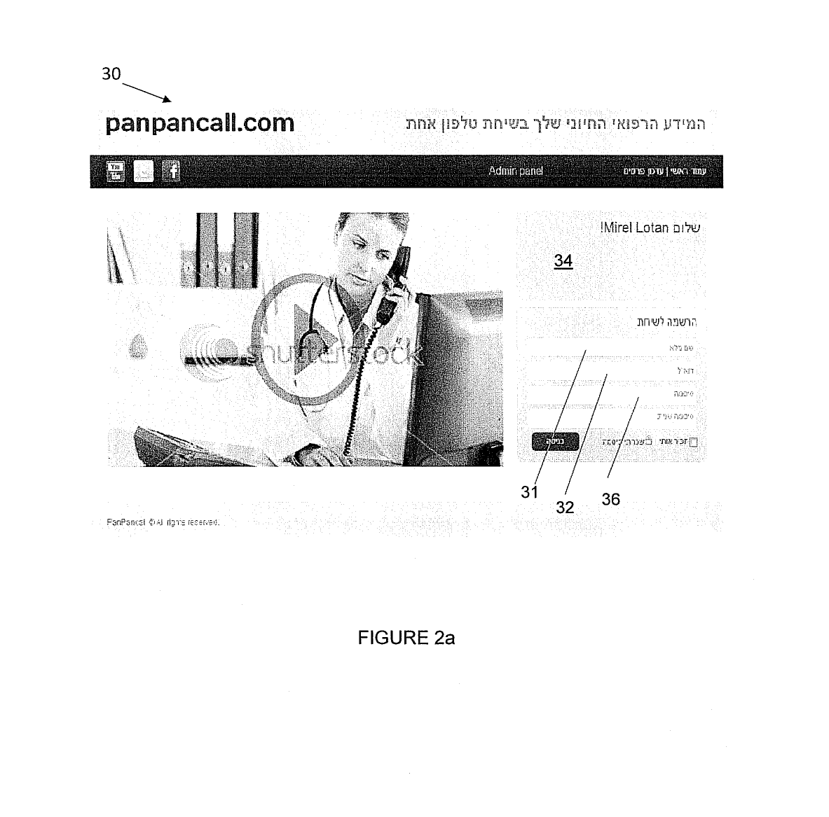

The method of operation of the system 10 is as follows. A subscriber uses an Internet enabled device 16 (such as a computer, tablet or smart-phone) to navigate, via the Internet, to a sign-in page 30 of a web site sitting on the server. One example of such a sign-in page is shown in FIG. 2. If the subscriber is a new subscriber, he then inputs his personal information, e.g., full name 31 and valid e-mail address 32, and the system 10 assigns him an editing password, a retrieval password, and an IVR password, which may be the same as the retrieval password. A returning subscriber, who wishes to enter or update his or her personal medical information, uses his or her username 34 and editing password 36 to sign-in and to enter the system's website. After signing in, a subscriber can use the system's server 12 to enter his personal medical information into the system's database 14 for storage. At the end of the medical information update, the subscriber merely press the “save” button to store the updated information in the database.

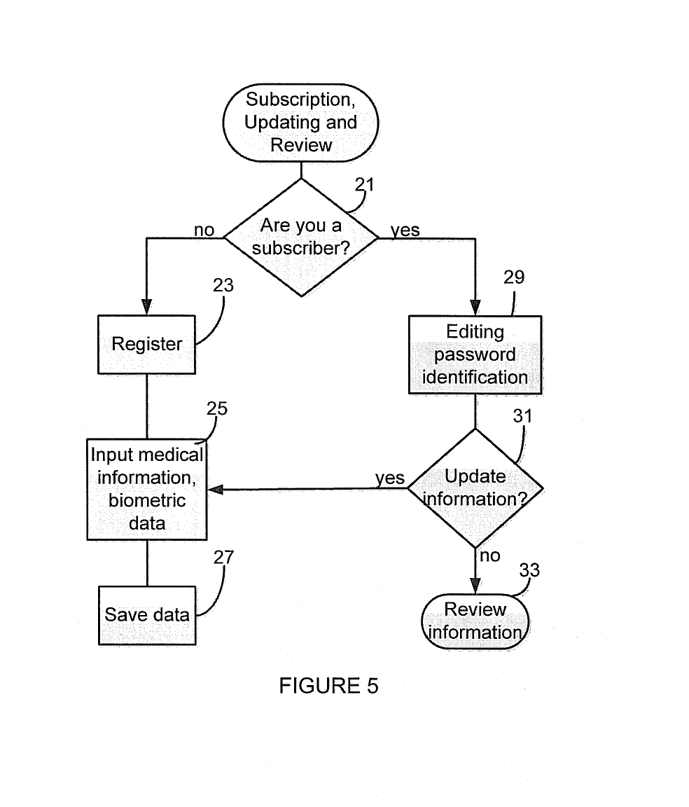

One example of an exemplary registration and update process is shown in the flow chart of FIG. 5. As can be seen, the subscriber enters the site and is asked whether he is a subscriber (block 21). If he is not, he registers on the web site (block 23), as described above. He or she inputs (block 25) all relevant medical information, as well as biometric and other personal identification data, and saves the data (block 27) in the web site's database. When the subscriber wishes to review or update his information, the subscriber identifies him or herself by his site or editing password identification (block 29) and selects review (block 33) or update (block 33), in which case he is directed to input or update the required information and/or data (block 25).

The input method of the personal medical information into the system's database 14, can be simplified by separating the information to be entered into a number of main categories, as shown, for example, in FIG. 2b. These categories may include, but are not limited to, blood information, such as blood type, blood sugar and cholesterol levels, allergies 11, medical problems (issues), current medications 13, current vaccinations 17, and additional e-mail addresses, fax numbers, Facebook and/or Twitter accounts to which the subscriber is interested in sending messages in case of emergency, e.g., using the IVR system 18 and a suitable communication system, as described below. Preferably, each category includes a tool bar with a search engine and auto-complete, to help the subscriber enter his or her personal medical information without spelling mistakes. When the subscriber has finished entering the medical information using the system's website, he or she can click on a link to contact the system's server 12 and save the information in the system's database 14.

After a subscriber enters and saves his or her personal medical information, it is securely stored in the systems database 14, ready to be used at any time. The information can be updated by the subscriber using the system's website (as described above), or accessed for retrieval and forwarding of medical data by the IVR system 18 to a medical practitioner in an emergency, as described below.

In order to allow the safest access to private medical information in case of an unconscious condition, a biometric system has been integrated to the database as a component of the subscriber identification data. All biometric systems follow the same general process of enrollment, comparison, and identification. As part of the subscription process, the subscriber can input selected biometric data into the system's database 14, using the system's server 10 and associated with the subscriber's medical information. This biometric data may include, but is not limited to, fingerprints, collected using a portable scanner or a smart-phone screen, a photograph provided for facial recognition, dental records used for dental recognition, a voice recording for voice recognition, retinal identification, input using a scanner device, such as a smart-phone screen, or DNA profiling, input and checked by a portable DNA test device, such as a Spartan real-time DNA Analyzer, (http://www.spartanbio.com/products/spartan-dx/) and/or any other biometric data useful for identification purposes. This biometric data can be used as subscriber identification data by the ID unit 15 to identify the subscriber in time of emergency or other medical care, and serve as a password to permit retrieval of personal medical information. This system, for the first time, enables real-time identification of unconscious people in the field, including their medical background, in order to select the best individual medical treatment in order to increase the chances of saving lives, while maintaining confidentiality secured from unauthorized retrieval.

The data stored in the system's database 14 (and accessed by the system's server 10), can be secured at a very high level of security as required for medical information. Preferably, the subscriber's retrieval password will not permit editing of the subscriber's medical information. Each of the subscriber's passwords can be recovered by the subscriber and sent to his personal e-mail, in case the subscriber forgets or loses them, and can preferably be chosen or changed by the subscriber.

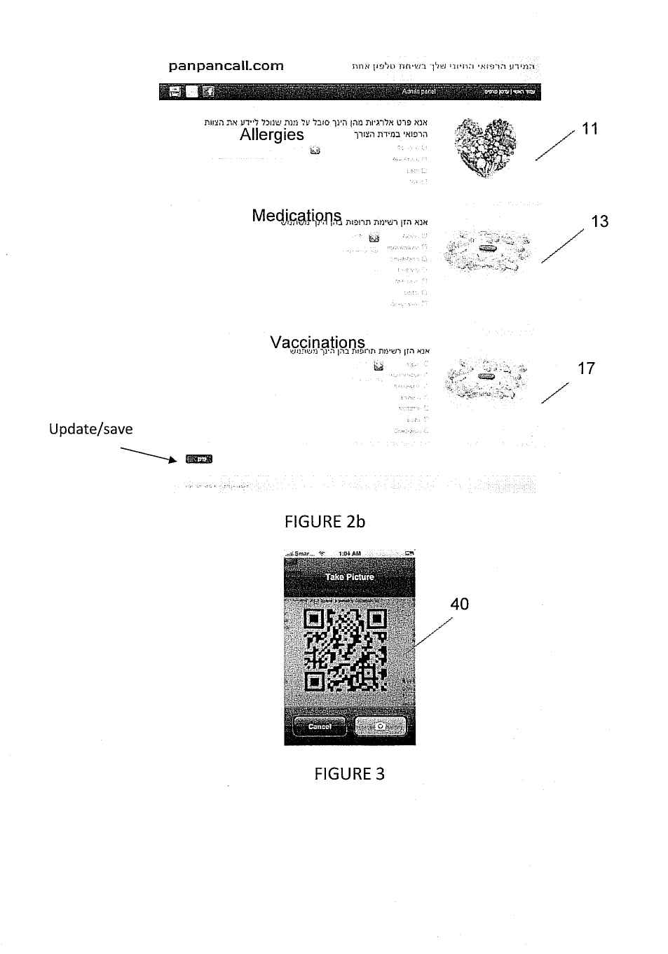

An additional or alternative identification channel is the Quick Response (QR) code. According to some embodiments, a personal QR code 40, as shown in FIG. 3 (or bar code or any other suitable graphic code) is generated. Such a QR code 40 can be used to identify the URL of the server's web site so that an Internet-enabled device 16 can be used to photograph the code and access the server 12 more quickly to retrieve the medical information about the subscriber. After the QR code 40 is scanned by an Internet-enabled device 16, as by a rescue worker or other medical practitioner, a browser on the Internet-enabled device 16 is opened to the page displaying the subscriber's personal medical information, substantially the same as the one displayed to a visitor who entered the visitor password, or to a caller who scanned the subscriber's biometric data. Entering any of the subscriber's subscriber identification data, e.g., password, IVR password, retinal identification, DNA test results or scanning the QR code, will all permit retrieval of the subscriber's medical information. In an emergency, any calling device 20 can be used by a caller to contact the system's IVR system 18 (via a phone line or the Internet). The IVR system 18 uses the subscriber identification data provided by the caller to identify the injured subscriber, based on the corresponding data stored in the system's database 14. No Internet connection is required, just access to any telephone device.

After identification and/or verification by the ID unit 15, the IVR system 18 provides the caller with a menu of options for transfer of the personal medical information (e.g., over the phone line, by fax, SMS, MMS, video) and possible media (such as voice, text, image, video, etc.) for providing or displaying the subscriber's personal medical information that is stored in the database 14. After a manner is chosen, the IVR system 18 contacts the system's server 12 to access the system's database 14 and provide the subscriber's personal medical information in the chosen manner. The personal medical information is then provided to an EMS worker, Emergency Medical Technician (EMT), paramedic, doctor or other medical practitioner in the chosen medium, on site, preferably in real-time.

In one embodiment, the IVR system 18 menu also includes a Text To Speech (TTS) option. This is particularly useful when the origin of some medical information is a paper sheet and not a digital medium. In order to avoid mistakes and assure consistency, the written information can be transformed to voice. The personal medical information is converted from text to a voice file, which can be sent by the IVR system 18 (or server 12) via the Internet or read to the caller over the phone line. This option allows a medical care giver to listen to the stored personal medical information read to them over the phone by the IVR system 18, if desired, in the local language. In remote locations that do not have access to fax machines, Internet or smart-phones, the personal medical information can be heard from the calling device 20 itself, using the IVR system 18.

The IVR system menu can optionally include sending a voice-message to any e-mail address preselected in the database by the subscriber, and/or an SMS to any phone number, including the stored medical information. The IVR system 18 menu preferably also includes the option to record a message on site in the form of voice, video, text (SMS), picture (MMS), etc. and send the recorded message. Alternatively, the message may be pre-recorded. The message may be sent by the server 12 over an appropriate communication system to at least one preselected e-mail address, i.e., belonging to rescue workers or friends or family, local emergency rescue authorities, and/or to a social network page. This allows the caller to send a message over the Internet without being directly connected to it. These messages are preferably free of charge to subscribers, although, alternatively, a fee can be charged for sending them. According to some embodiments, the geographical location identification unit 22 identifies the language of the area at the location of the calling device 20 into which the recording should be translated and selects, by default, the closest location to which to send the message. The translation unit 26 then permits the subscriber to use the system 10 to send the recorded message with the location of the calling device 20 to the rescue forces over a communication system, translated into the local language.

Alternatively, the database 14 can be accessed by a care provider using any Internet-enabled device 16 by going to the website and signing in using the retrieval password or by scanning the QR code. Preferably, this option also allows the subscriber's personal medical information to be viewed translated into a selected language, and/or transferred via the desired channel.

Although the personal medical information entered by a subscriber cannot be edited by a caller or visitor, some embodiments permit the inclusion of notes, in an attached file or in the events log, indicating, for example, what treatment was performed or what medication was administered. This option is particularly useful if the subscriber is later admitted to a hospital or other care facility after preliminary on-site treatment. The next caretaker who wishes to view the subscriber's medical history, will be able to retrieve not only the personal medical information input by the subscriber, but also what preliminary diagnosis, treatment and/or medication was administered on-site, before administering further treatment. This system allows not only the most suitable individual medical care but also a permits tracking of the medical process, enabling the medical practitioner to analyze the big picture.

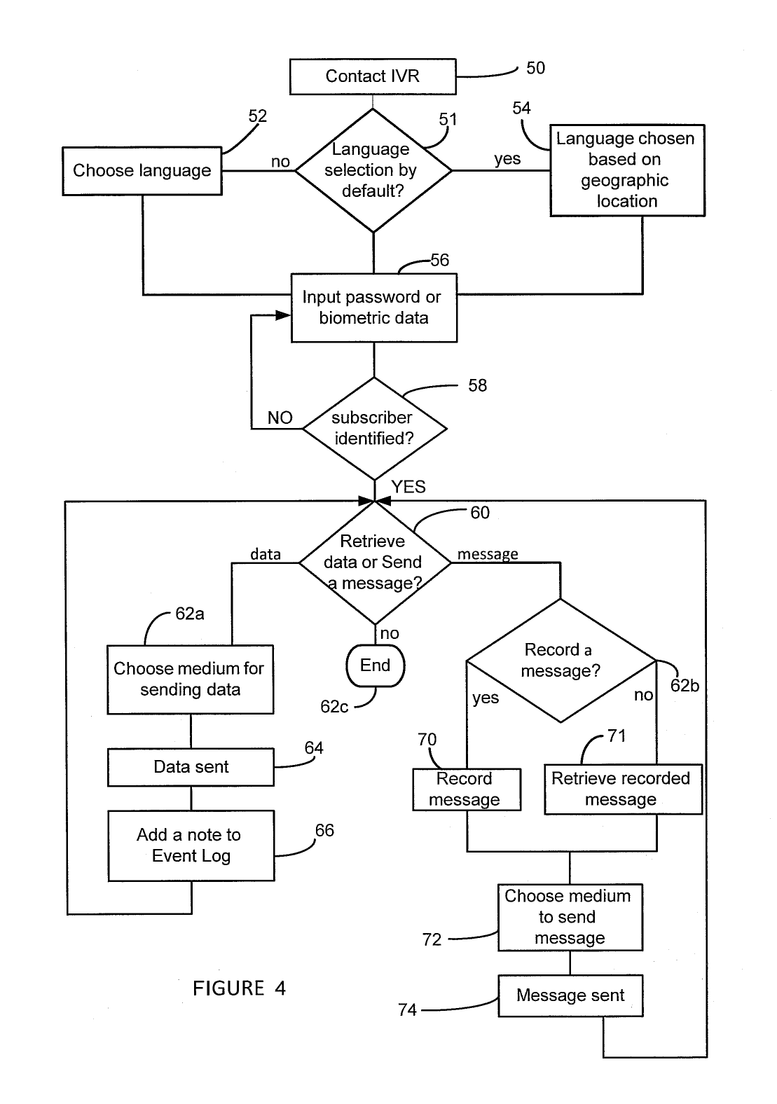

FIG. 4 is a block diagram illustrating a method of retrieving personal medical information and sending messages using an IVR system, according to one embodiment of the present invention. In case of a personal emergency, a caller (e.g. the injured subscriber (if he is conscious) or a medical practitioner (if the injured subscriber is unconscious or incapable of placing the call) uses a calling device to call the IVR system (block 50). If the language is not chosen by default (block 51), the IVR system first asks the caller to choose a menu language (block 52) or automatically chooses a menu language based on the geographic location of the calling device (block 54). After the language has been selected, the IVR system prompts the caller to input subscriber identification data (block 56), so as to unequivocally identify the subscriber. Using the input data, the ID unit attempts to identify the subscriber based on the input subscriber identification data (block 58). If the subscriber is not identified by the ID unit, the IVR system once again asks the caller to input subscriber identification data (block 56).

After the IVR system compares the provided data with the data stored in the system's database and the subscriber has been identified by the ID unit, the IVR will prompt the caller to indicate if he would like to retrieve the subscriber's personal medical information or send a message (block 60). If the caller selects to retrieve the subscriber's personal medical information, the IVR system then prompts the caller to choose a medium or channel over which to receive the subscriber's personal medical information (over the phone, as a text, e-mail, fax, etc.) (block 62a). The caller selects the desired channel: IVR voice, SMS, fax, e-mail, smart-phone application, and, if needed, an address to which to send the information, and the subscriber's personal medical information is retrieved from the database and sent to the caller via the desired channel (block 64). Now, the medical practitioner can provide the proper medical treatment to the injured subscriber, thereby increasing his or her chances for survival.

After the medical information has been analyzed and the medical treatment completed, optionally, the caller may add a note [block 66] to the event log, or to another file stored with the medical information of the subscriber, describing any treatment or medications administered, possible diagnosis, etc. Alternatively, the note may be stored temporarily and added to the description of the event sent to the Event Log after the call has been completed. The IVR system then once again asks the caller if he would like to retrieve the subscriber's personal medical information or send a message (block 60).

If the caller chooses to send a message, the IVR system asks the caller if he would like to record a message or send a prerecorded message (block 62b). This option can be used by a subscriber trapped or injured during a national emergency or mass disaster to send messages to the authorities, who can direct the EMS workers or other rescue parties, and help them operate more efficiently. This option can also help a subscriber who is lost to inform the authorities of his or her location for rescue. This option can also be used during an emergency by a non-injured subscriber to send messages to family and friends to inform them of the subscriber's safety.

If the caller selects to record a voice message, he records it (block 70). If he indicates a pre-recorded message, he selects the desired message (if more than one are available) (block 71). The IVR system then asks the caller to select a medium or channel for sending the recorded message (as a text, e-mail, etc.) (block 72). After a medium for sending a message has been chosen, the message is sent via the desired medium (block 74) to the desired predefined address or e-mail. For example, the caller can send a free voice message to the local information center including his or her exact location, preferably including the subscriber's current medical condition, and the condition of anyone trapped with him. The IVR system contacts the system's server and causes it send the voice message to the local information center's (authorities) e-mail. The system's server enters every single call as a new log entry in the Event Log saved in the system's database. The local information center receives the message, sends the relevant rescue force to the subscriber's location, and enters repeatedly to re-check the Event Log to see if each event has been resolved. If unresolved, the local information center contacts again the person in charge of the rescue workers in the field. The person in charge directs the rescue workers to the exact location where the trapped subscribers are located, so they can rescue them as quickly as possible. This method is often better than conventional manned emergency call-centers because it can handle practically unlimited message traffic without collapsing under the traffic load and wait time.

The health condition of the trapped subscriber when the rescue workers arrive determines their next course of action. If the subscriber is unconscious (or deceased) the practitioner will identify the subscriber using any appropriate biometric means of identification, as described above. If the subscriber is conscious, the proper medical treatment, in accordance with the subscriber's recorded personal medical information, can be performed on-site on the injured subscriber. Then, the IVR system, once again, asks the caller if he would like to retrieve the subscriber's personal medical information or send a message (block 60) or end the call (block 62c). An entry for the call is then automatically added into the Event Log.

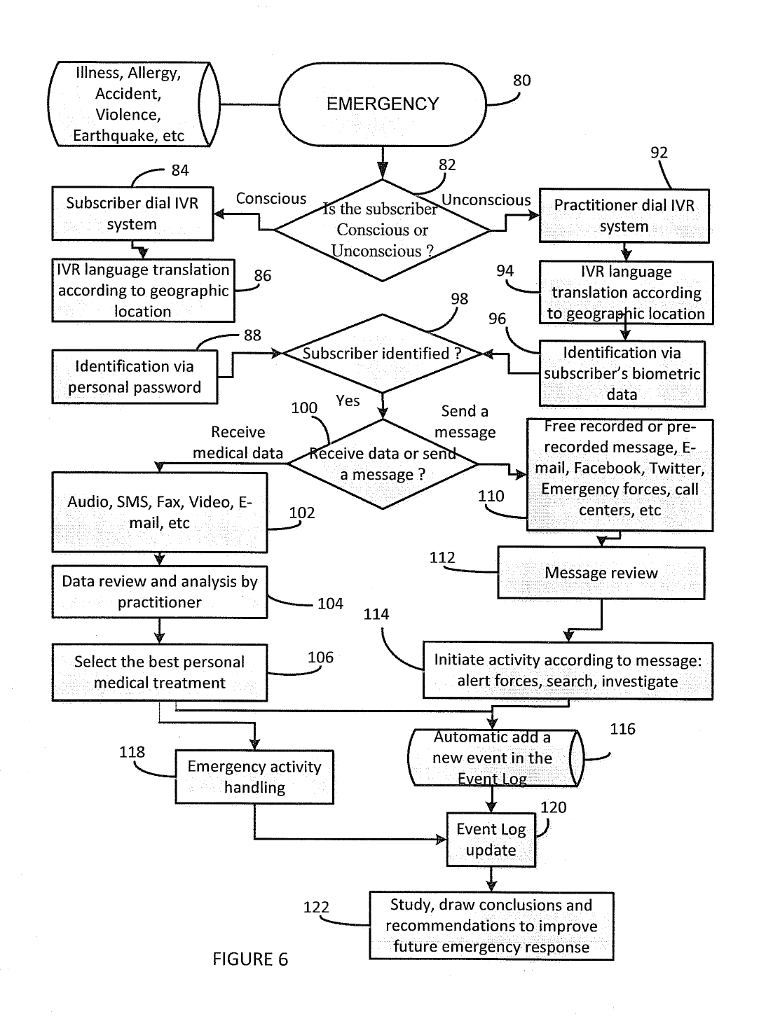

FIG. 6 is a flow chart of another exemplary method of use of the system during an emergency (block 80). Such an emergency can be a personal emergency, such as a severe allergy attack, illness or accident, or can be public emergency, such as a terrorist attack or earthquake, etc. There are essentially two lines of operation, depending on whether the subscriber is conscious or unconscious (block 82). If the subscriber is conscious, he himself can dial the IVR system (block 84). The IVR can be programmed by default to answer in the language according to the geographic location of the caller (block 86). The subscriber now identifies him or herself via his personal password (block 88).

The alternative route is when the subscriber is unconscious or otherwise unable to place the call. In this case, a practitioner will dial the IVR system (block 92). The IVR answers in the language according to the geographic location of the caller (block 94), translating as required. The practitioner now tries to identify the subscriber via his or her biometric data (block 96).

Once the subscriber has been identified (block 98), the subscriber or the practitioner selects whether to receive data or send a message (block 100). If the selection is to receive medical data, the caller is directed to select the method of delivery (block 102), i.e., audio, SMS, facsimile, video, e-mail, etc. When the data is received, it is reviewed and analyzed by the practitioner on site (block 104), who then selects the best medical treatment for that person based on his or her medical information (block 106).

If, on the other hand, the decision is to send a message, the subscriber or practitioner selects a free recorded or pre-recorded message and selects a destination, e.g., a pre-selected e-mail address, social network, emergency forces, call center, etc. (block 110). These free voice messages, by each subscriber, to the local rescue forces and/or to family, make it easier to locate the subscriber and initiate rescue activity in case of a mass destruction event, such as earthquakes. These voice messages are practical life signs from trapped people to which the rescue forces can be directed.

The received message is reviewed (particularly in the case of emergency forces or an emergency call center) (block 112), and suitable activity is initiated, according to the message (block 114), i.e., alert a call center to the occurrence of the emergency, instigate a search for the subscriber, send medical care to the subscriber, investigate the event, etc.

Upon completion of preliminary medical treatment (block 106) or initiation of activity in response to the message (block 114), a new entry recording this particular call is added, preferably automatically, to the Event Log (block 116). In the event that further handling is required (block 118), the event log is updated (block 120). In this way, the final goal of reducing the risks to life in medical and emergency situations can be reached.

After rescue, the person in charge in the rescue workers in the field will report back to the local information center. The local information center will then update the status of each event logged in the Event Log as resolved. The Event Log helps local information centers and rescue workers to manage and track rescue efforts.

Since it is an integral part of the database, the Event Log is saved and backed up. The Event Log can be accessed and studied after an event to permit the drawing of conclusions for performance improvement purposes and provide recommendations to improve future emergency responses (block 122). This unique on-line Event Log is an excellent tool for studying, receiving customer feedback and improving in preparation for future events. It will be appreciated that the data of a medical nature that is stored in the event log is associated with a subscribers' identification. While the medical information is available for statistical analysis, etc, the identification of the subscriber associated with that medical data is available only to authorized persons using the subscriber's identification means, so that only this authorized personnel can associate the medical information with the proper subscriber.

Since the system can be used to identify unconscious injured subscribers based on their biomedical data, it can also be used to quickly and reliable identify casualties in case of mass casualty incident (such as terror act, or an earthquake or other natural-disaster). Quick identification of casualties prevents unmarked or mass graves. It will be appreciated that the invention also provides the capability to collect biometric identification data from an unconscious injured person, who is not a subscriber, on-site. This information can be stored in the events log, even without the person's name, and the information can be made available for further treatment of the person identified using the same biometric identification means. It will be appreciated that this information can only be accessed by authorized individuals. In this way, potential subscribers are created who can choose to become subscribers later on, by updating their medical information and biometric data to include all their other medical information. Alternatively, the personal data can be deleted or retrieved by the injured non-subscriber at his later request.

In case of an emergency, information centers are opened in every affected area for the good of the public. Subscribers to this system benefit from a unique, efficient and useful communication channel, since their calls for help will immediately reach the Event Log, which is viewed and managed in a central location, without delay. The information centers check the Event Log to direct the rescue forces on location in accordance with each call registered by the IVR system. This method is effective and will make better use of the limited resources that are deployed in these types of events.

While the invention has been described hereinabove often with reference to an emergency event, the invention can alternatively be utilized in any visit to a doctor or for any kind of medical treatment, where it is crucial to know allergies or other medical constraints of the patient, which may not be remembered by the subscriber.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A system comprising:
a memory device storing a database of personal medical information associated with personal identification data;
a server including a controller coupled to the memory device for managing the personal medical information in the database and retrieving at least some of the personal medical information from the database,
an Interactive Voice Response (IVR) system coupled to said server and accessible by a calling device;
a subscriber identification unit in said server for identifying a subscriber according to at least some of said personal identification data stored in said database and personal identification data received by said IVR system;
an automatic language translation unit coupled to said IVR system and configured to selectively translate the IVR system's menu to a language understood by a caller to the IVR system;
a geographic location identification unit coupled to said IVR system and configured to determine a geographic location of the calling device and outputs a signal corresponding to said determined geographic location.

2. The system according to claim 1, further comprising an event log in which data of each call received by said IVR system is automatically recorded.

3. The system according to claim 1, wherein said personal identification data includes biometric identification data.

4. The system according to claim 1, wherein said IVR system is further configured for sending a message for an identified subscriber over said telephone communication system.

5. The system according to claim 1, wherein said personal identification data includes a password or graphic code associated with each subscriber.

6. The system according to claim 1, wherein translation unit is configured to automatically select a language according to said identified geographic location.

7. The system according to claim 1, wherein said IVR system is configured to provide a menu to said caller for selecting a language for communication with said IVR system.

8. A method for providing personal medical information of a subscriber, the method comprising:
receiving, in an Interactive Voice Response (IVR) system coupled to a memory device, an incoming call from a calling device;
identifying a geographical location of said calling device;
selecting, in said IVR, a language in which to communicate during said call;
receiving personal identification data by said IVR system from said calling device;
identifying a subscriber, having personal medical information and personal identification data stored in said memory device, from said received personal identification data; and
automatically retrieving at least some of the personal medical information of said identified subscriber from the memory device.

9. The method according to claim 8, further comprising automatically recording data of each incoming call received by said IVR system in a stored event log.

10. The method according to claim 8, further comprising recording data of medical services provided to said subscriber together with subscriber identification data in said event log.

11. The method according to claim 8, wherein said step of selecting includes automatically selecting a local language associated with said identified geographical location and translating communications from said IVR into said local language.

12. The method according to claim 8, wherein said step of selecting includes providing a menu in said IVR to permit selection of one of a local language, a subscriber's language, or another language.

13. The method according to claim 8, wherein said step of identifying a subscriber includes identifying a subscriber by means of said stored biometric data.

14. The method according to claim 8, wherein said step of identifying a subscriber includes identifying a subscriber by means of a password or graphic code associated with that subscriber.

15. The method according to claim 9, wherein said step of identifying a subscriber includes identifying a subscriber by means of said stored biometric data.

16. The method according to claim 9, wherein said step of identifying a subscriber includes identifying a subscriber by means of a password or graphic code associated with that subscriber.

17. The method according to claim 10, wherein said step of identifying a subscriber includes identifying a subscriber by means of said stored biometric data.

18. The method according to claim 10, wherein said step of identifying a subscriber includes identifying a subscriber by means of a password or graphic code associated with that subscriber.
